(19) United States
(12) Patent Application Publication
(10) Pub. No.: US 2025/0309589 A1
(43) Pub. Date: Oct. 2, 2025

(54) Shield, Communication Connector and Developed Metal Plate

(71) Applicant: TE Connectivity Japan G. K., Kawasaki-shi (JP)

(72) Inventor: Shinichi Hirota, Kawasaki-shi (JP)

(73) Assignee: TE Connectivity Japan G. K., Kawasaki-shi (JP)

(21) Appl. No.: 19/093,365

(22) Filed: Mar. 28, 2025

(30) Foreign Application Priority Data
Mar. 29, 2024 (JP) 2024-055625

(51) Int. Cl. H01R 13/6582; H01R 13/6586

(52) U.S. Cl. CPC H01R 13/6582; H01R 13/6586

(57) ABSTRACT

A shield formed by bending a metal plate includes a first shield portion, a second shield portion adjacent to the first shield portion, a fourth shield portion adjacent to the first shield portion and opposite to the second shield portion, and a third shield portion adjacent to each of the first shield portion, the second shield portion, and the fourth shield portion. The third shield portion includes a first shield sub-portion contiguous to the second shield portion and a second shield sub-portion contiguous to the fourth shield portion.

### CROSS-REFERENCE TO RELATED APPLICATION

This application claims the benefit of the filing date under 35 U.S.C. § 119(a)-(d) of Japanese Patent Application No. 2024-055625, filed on Mar. 29, 2024.

### FIELD OF THE INVENTION

The present invention relates to a shield assembled to a communication connector, the communication connector, and a developed metal plate.

### BACKGROUND OF THE INVENTION

A connector for communication has an anti-noise shield assembled thereto that covers a housing accommodating a terminal portion for communication. Japanese Patent Application JP2018-137158A discloses a rectangular-cuboid-shaped boxy shield having two faces opened, which is formed by bending a metal plate. The shield of JP2018-137158A covers a top face, widthwise opposite side faces, and a rear face of a rectangular-cuboid-shaped housing of a connector. Before bending, a blank of such a shield is generally T-shaped.

A shield formed by bending a metal plate is produced by progressive processing, for example, repeating the process of feeding a coiled metal strip at a predetermined feed pitch and stamping it using a die. For such a generally T-shaped blank as in the JP2018-137158A, feeding is performed at a predetermined feed pitch in the vertical direction of the letter T, and, if stamping is performed using a die, the feed pitch is determined based on a dimension in the vertical direction of the T-shape.

In the progressive processing, a shorter feed pitch of the coiled metal strip shortens feed takt time, so that the number of times of stamping using a die per unit time can be increased, and further the material to be used can be reduced. There is a need to shorten process takt time and reduce material cost while ensuring an anti-noise shielding function.

### SUMMARY OF THE INVENTION

A shield formed by bending a metal plate includes a first shield portion, a second shield portion adjacent to the first shield portion, a fourth shield portion adjacent to the first shield portion and opposite to the second shield portion, and a third shield portion adjacent to each of the first shield portion, the second shield portion, and the fourth shield portion. The third shield portion includes a first shield sub-portion contiguous to the second shield portion and a second shield sub-portion contiguous to the fourth shield portion.

### BRIEF DESCRIPTION OF THE DRAWINGS

The invention will now be described by way of example with reference to the accompanying figures, of which:

FIG. 1 is an isometric view showing a communication connector according to a first embodiment of the present invention;

FIG. 2 is an isometric view showing a shield according to the first embodiment of the present invention;

FIG. 3 is a blank of the shield according to the first embodiment of the present invention;

FIG. 4 is a top view showing the communication connector according to the first embodiment of the present invention;

FIG. 5 is a partial cross-sectional view along a line V-V in FIG. 4;

FIG. 6A is a top view showing a communication connector according to a second embodiment of the present invention;

FIG. 6B is a detail view of a shield portion of the communication connector shown in FIG. 6A having a first tapered portion;

FIG. 6C is a detail view of a shield portion of the communication connector shown in FIG. 6A having a second tapered portion;

FIG. 7 is a front view in the course of bending of the shield according to the second embodiment of the present invention; and

FIG. 8 is a diagram of a clearance portion of the shield according to the second embodiment of the present invention.

### DETAILED DESCRIPTION

With reference to the accompanying drawings, a communication connector 1 having a shield 10 assembled to a housing 100 that is formed by bending a metal plate and the shield 10 according to a first embodiment of the present invention will be described below.

It should be noted that, for illustrative convenience, a first direction Z, a second direction Y orthogonal to the first direction Z, and a third direction X orthogonal to the first direction Z and the second direction Y are defined as shown in each of the drawings. In addition, (U) is upward in the first direction Z, (D) is downward therein, (R) is rightward in the second direction Y, (L) is leftward therein, (F) is frontward in the third direction X, and (B) is downward therein.

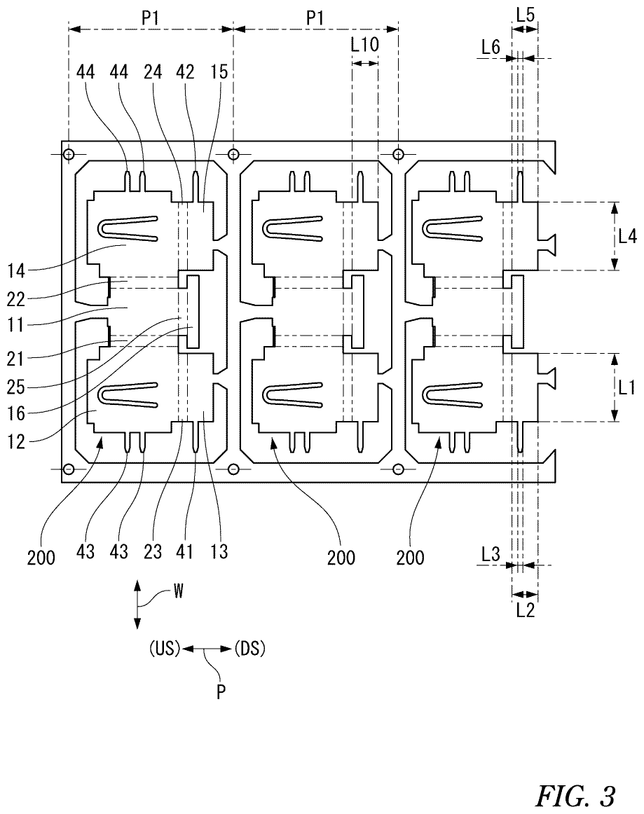

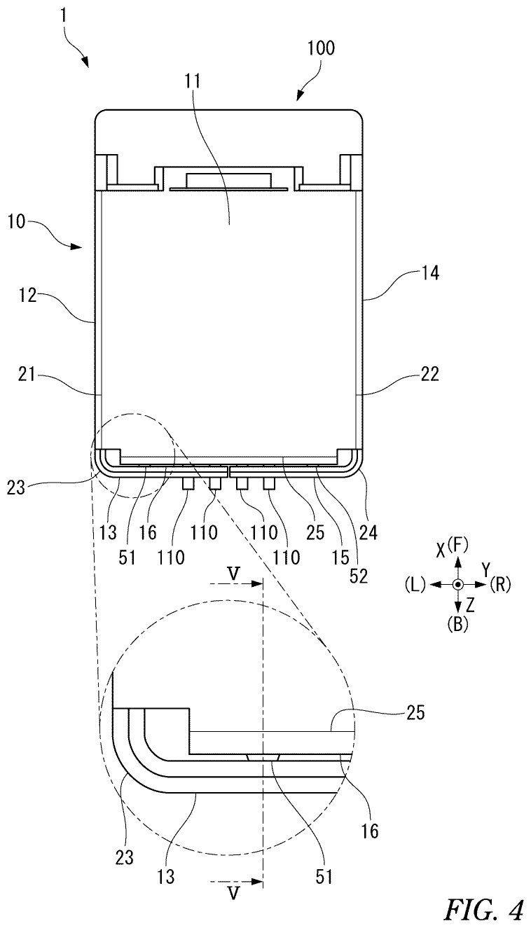

In FIG. 3, a direction in which a coiled metal strip is fed is a feed direction P as a fifth direction, and a direction orthogonal to the feed direction P is a width direction W as a fourth direction. In addition, (US) is upstream in the feed direction P, and (DS) is downward therein.

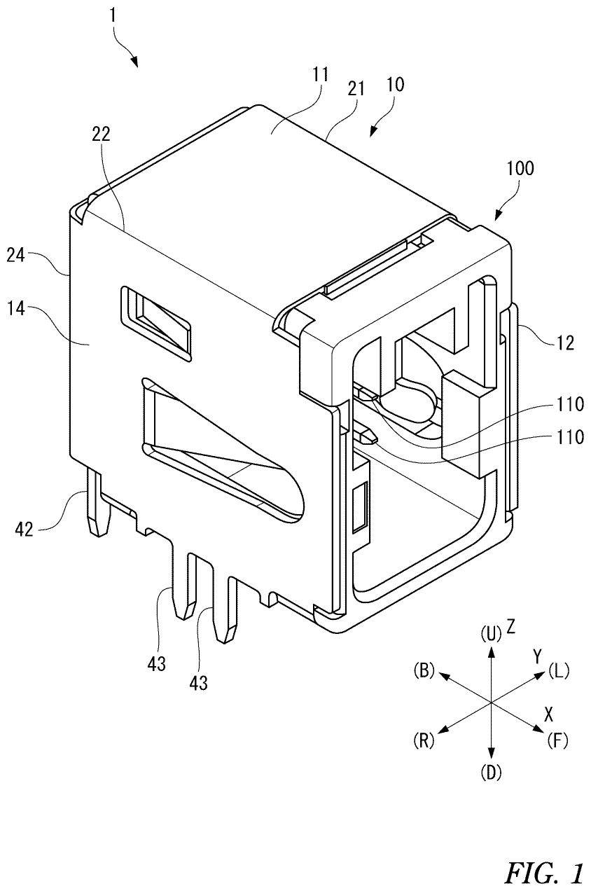

As shown in FIG. 1, the communication connector 1 includes the shield 10 formed by bending a metal plate, the housing 100 having the shield 10 attached thereto, and a plurality of contact portions 110. The communication connector 1 is mated with a mating connector, and the contact portions 110 are electrically connected to contact portions of the mating connector. In addition, the communication connector 1, when mounted on a board, has the contact portions 110 electrically connected to contact portions of the board to relay communication signals to the board.

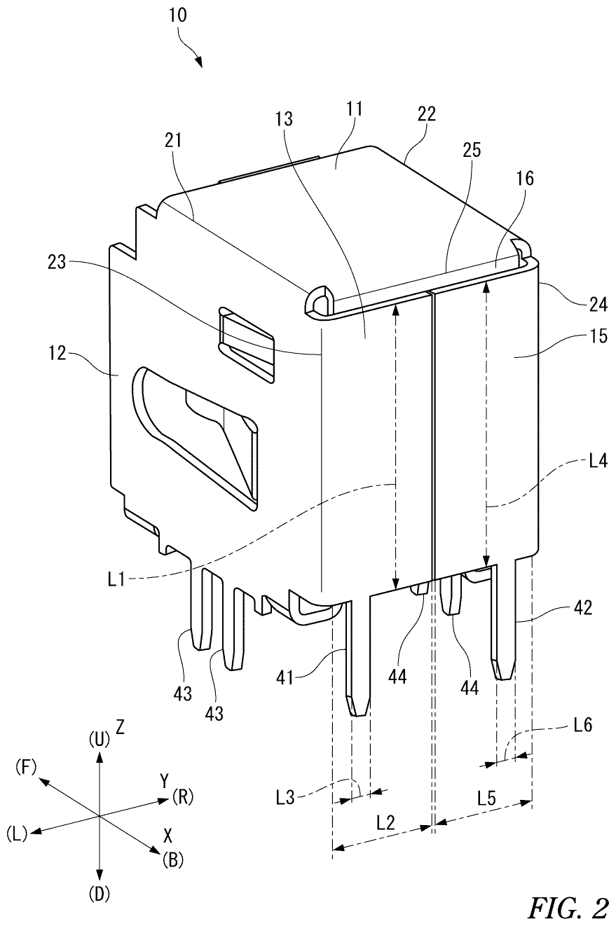

As shown in FIGS. 1 and 2, the shield 10 formed by bending a metal plate is formed with a plurality of bend portions along which the metal plate is bent in the same direction, and includes a plurality of shield portions adjacent to each other via the bend portions. The shield 10 is composed of a first shield portion 11 covering the upward U side in the first direction Z of the housing 100, a second shield portion 12 covering the leftward L side in the second direction Y of the housing 100, a fourth shield portion 14 covering the rightward R side in the second direction Y of the housing 100, a third shield portion 13 and a fifth shield portion 15, as a first shield sub-portion and a second shield sub-portion of the present invention, respectively, covering the rearward B side in the third direction X of the housing 100, and a sixth shield portion 16 interposed between the housing 100 and the third shield portion 13 and the fifth shield portion 15. The first shield portion 11 is orthogonal to the first direction Z, and the second shield portion 12 is orthogonal to the second direction Y.

The shield 10 is formed with a first bend portion 21 and a second bend portion 22 on opposite sides in the second direction Y of the first shield portion 11. That is, the first shield portion 11 is interposed between the first bend portion 21 and the second bend portion 22. It should be noted that the first bend portion 21 and the second bend portion 22 are bend portions extending in the third direction X.

As shown in FIG. 2, the first shield portion 11 is adjacent to the second shield portion 12 via the first bend portion 21. That is, the second shield portion 12 is adjacent to the first shield portion 11.

The second shield portion 12 covers the leftward L side in the second direction Y of the housing 100. The second shield portion 12 is formed with two lead portions 43 extending downward D in the first direction Z. The lead portions 43 are mounting portions that are through-hole mounted on the board when the communication connector 1 is mounted on the board. The lead portions 43 are inserted into through-holes in the board and soldered to be firmly secured to the board at the time of mounting. The lead portions 43 are conductively connected to the board, thereby grounding the shield 10.

In addition, the second shield portion 12 is adjacent to the third shield portion 13 via a third bend portion 23 along which the second shield portion 12 is further bent. That is, the third shield portion 13 is contiguous to the second shield portion 12.

The third shield portion 13 covers the rearward B side in the third direction X of the housing 100 together with the fifth shield portion 15. A length in the first direction Z of the third shield portion 13 is a height L1, and a length in the second direction Y thereof is a width L2.

The third shield portion 13 is formed with a lead portion 41 extending downward D in the first direction Z. A length in the second direction Y of the lead portion 41 is a width L3, which is a length equal to or less than the width L2 of the third shield portion 13. The width L3 of the lead portion 41 is set to a predetermined length in a range of the width L2 or less in the second direction Y that is a plate width direction of the third shield portion 13.

The lead portion 41 is a mounting portion that is through-hole mounted on the board when the communication connector 1 is mounted on the board. The lead portion 41 is inserted into a through-hole in the board and soldered to be firmly secured to the board at the time of mounting. The lead portion 41 is conductively connected to the board, thereby grounding the shield 10.

When an operator mates the communication connector 1 with the mating connector, a three-dimensional load may occur on a mounting area between the board and the lead portion 41. Since the lead portion 41 is the mounting portion firmly secured to the board, and is set to the predetermined length in the second direction Y that is the plate width direction of the third shield portion 13, the lead portion 41 can be set to have a predetermined resistance to a load in the second direction Y on the communication connector 1 including the shield 10.

Therefore, the shield 10 can improve resistance against separation of the shield 10 from the board when the load in the second direction Y is applied. In addition, the communication connector 1 including the shield 10 can improve resistance against separation of the communication connector 1 from the board when a load in the second direction Y caused by the mating operation of the operator is applied.

It should be noted that, in order to improve resistance to a load in the second direction Y of the lead portions 43 formed on the second shield portion 12, the plate thickness of the second shield portion 12 needs to be thickened. Thickening the plate thickness of the second shield portion 12, however, means thickening the plate thickness of the metal plate itself for the shield 10, causing an increase in material cost.

In contrast, since the lead portion 41 is set to the predetermined length in the second direction Y that is the plate width direction of the third shield portion 13, the plate thickness of the metal plate itself for the shield 10 does not need to be thickened. That is, the lead portion 41 can be set to have a predetermined resistance to the load in the second direction Y on the communication connector 1, without increasing material cost.

As shown in FIG. 1, the first shield portion 11 is adjacent to the fourth shield portion 14 via the second bend portion 22. That is, the fourth shield portion 14 is adjacent to the first shield portion 11.

The fourth shield portion 14 covers the rightward R side in the second direction Y of the housing 100. The fourth shield portion 14 is opposite to the second shield portion 12. The fourth shield portion 14 is formed with two lead portions 44 extending downward D in the first direction Z. The lead portions 44 are mounting portions that are through-hole mounted in the board when the communication connector 1 is mounted on the board. The lead portions 44 are inserted into through-holes in the board and soldered to be firmly secured to the board at the time of mounting. The lead portions 44 are conductively connected to the board, thereby grounding the shield 10.

As shown in FIGS. 1 and 2, the fourth shield portion 14 is adjacent to the fifth shield portion 15 via a fourth bend portion 24 along which the fourth shield portion 14 is further bent. That is, the fifth shield portion 15 is contiguous to the fourth shield portion 14.

The fifth shield portion 15 covers the rearward B side in the third direction X of the housing 100 together with the third shield portion 13. That is, the first shield sub-portion and the second shield sub-portion of the present invention composed of the third shield portion 13 and the fifth shield portion 15 is adjacent to each of the first shield portion 11, the second shield portion 12, and the fourth shield portion 14. The fifth shield portion 15 is aligned with and is adjacent to the third shield portion 13 in the second direction Y. In an embodiment, the fifth shield portion 15 and the third shield portion 13 are provided in the same plane. A length in the first direction Z of the fifth shield portion 15 is a height L4, and a length in the second direction Y thereof is a width L5.

The fifth shield portion 15 is formed with a lead portion 42 extending downward D in the first direction Z. A length in the second direction Y of the lead portion 42 is a width L6, which is a length equal to or less than the width L5 of the fifth shield portion 15. The width L6 of the lead portion 42 is set to a predetermined length in a range of the width L5 or less in the second direction Y that is a plate width direction of the fifth shield portion 15.

The lead portion 42 is a mounting portion that is through-hole mounted in the board when the communication connector 1 is mounted on the board. The lead portions 42 are inserted into a through-hole in the board and soldered to be firmly secured to the board at the time of mounting. The lead portion 42 is conductively connected to the board, thereby grounding the shield 10.

When an operator mates the communication connector 1 with the mating connector, a three-dimensional load may occur on a mounting area between the board and the lead portion 42. Since the lead portion 42 is the mounting portion firmly secured to the board, and is set to the predetermined length in the second direction Y that is the plate width direction of the fifth shield portion 15, the lead portion 42 can be set to have a predetermined resistance to a load in the second direction Y on the communication connector 1 including the shield 10.

Therefore, the shield 10 can improve resistance against separation of the shield 10 from the board when the load in the second direction Y is applied. In addition, the communication connector 1 including the shield 10 can improve resistance against separation of the communication connector 1 from the board when a load in the second direction Y caused by the mating operation of the operator is applied.

It should be noted that, in order to improve resistance to the load in the second direction Y of the lead portions 44 formed on the fourth shield portion 14, the plate thickness of the fourth shield portion 14 needs to be thickened. Thickening the plate thickness of the fourth shield portion 14, however, means thickening the plate thickness of the metal plate itself for the shield 10, causing an increase in material cost.

In contrast, since the lead portion 42 is set to the predetermined length in the second direction Y that is the plate width direction of the fifth shield portion 15, the plate thickness of the metal plate itself for the shield 10 does not need to be thickened. That is, the lead portion 42 can be set to have a predetermined resistance to the load in the second direction Y on the communication connector 1, without causing the increase in material cost.

The height L1 of the third shield portion 13 and the height L4 of the fifth shield portion 15 are set to be the same length, the width L2 of the third shield portion 13 and the width L5 of the fifth shield portion 15 are set to be the same length, and the width L3 of the lead portion 41 and the width L6 of the lead portion 42 are set to be the same length. The height L1 is larger than the length L2, and the height L4 is larger than the length L5. In the present embodiment, the height L1 is twice as long as the length L2. In addition, the height L4 is twice as long as the length L5.

The first shield portion 11 is adjacent to the sixth shield portion 16 via a fifth bend portion 25. That is, the sixth shield portion 16 is contiguous to the first shield portion 11.

The sixth shield portion 16 is interposed between the housing 100 and the third shield portion 13 and between the housing 100 and the fifth shield portion 15. That is, the sixth shield portion 16 is aligned with the third shield portion 13 and the fifth shield portion 15 in the third direction X. The sixth shield portion 16 is formed with a first dimple portion 51 as a first conduction path portion, and a second dimple portion 52 as a second conduction path portion on a face 16B on the rearward B side in the third direction X.

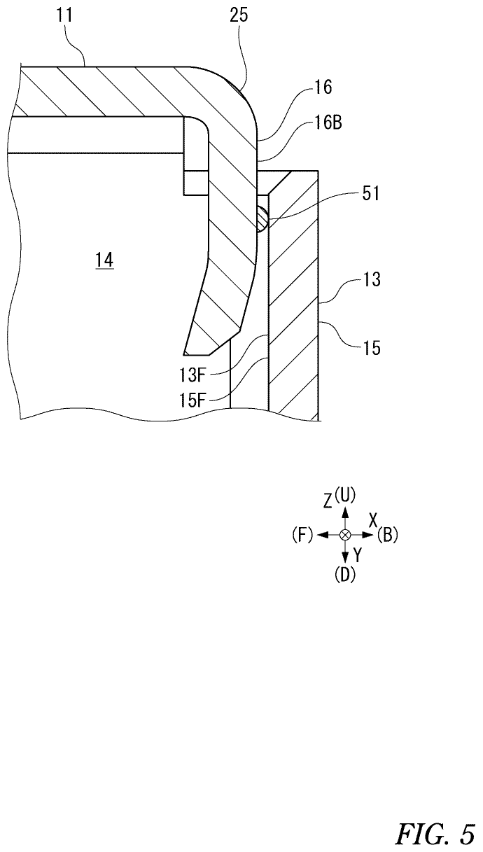

As shown in FIG. 5, the first dimple portion 51 presses a face 13F on the frontward F side in the third direction X of the third shield portion 13 to form a conduction path conductively connecting the sixth shield portion 16 and the third shield portion 13. The second dimple portion 52 presses a face 15F on the frontward F side in the third direction X of the fifth shield portion 15 to form a conduction path conductively connecting the sixth shield portion 16 and the fifth shield portion 15.

Since the sixth shield portion 16 adjacent to the first shield portion 11 is formed with the conduction path to the third shield portion 11, a conduction path can be formed along which electric current flows from the first shield portion 11 through the sixth shield portion 16, and then through the lead portion 41 of the third shield portion 13 to the board. In addition, since the sixth shield portion 16 adjacent to the first shield portion 11 is formed with the conduction path to the fifth shield portion 15, a conduction path can be formed along which electric current flows from the first shield portion 11 through the sixth shield portion 16, and then through the lead portion 42 of the fifth shield portion 15 to the board.

In this manner, since the conduction path from the first shield portion 11 on the upward U side in the first direction Z to the third shield portion 13 or the fifth shield portion 15 on the rearward B side in the third direction X is formed, conduction paths having a short conduction distance for releasing a noise-causing electric current to a portion that does not affect communication signals can be increased even in such a shield 10 formed by bending a metal plate that covers the rearward B side of the housing 100 with the two shield portions, namely the third shield portion 13 and the fifth shield portion 15, so that noise generation can be reduced.

In the present embodiment, the first dimple portion 51 and the second dimple portion 52 are formed on the sixth shield portion 16, but this is not a limitation. For example, the first dimple portion 51 may be formed on the third shield portion 13 such that the first dimple portion 51 presses the sixth shield portion 16 to conductively connect the sixth shield portion 16 and the third shield portion 13. In addition, the second dimple portion 52 may be formed on the fifth shield portion 15 such that the second dimple portion 52 presses the sixth shield portion 16 to conductively connect the sixth shield portion 16 and the fifth shield portion 15.

In addition, the first shield portion 11 may be extended rearward B in the third direction X, and be formed with two dimple portions on the downward D side in the first direction Z of the first shield portion 11 such that one of the dimple portions and the upward U portion in the first direction Z of the third shield portion 13 are conductively connected, and the other dimple portion and the upward U portion in the first direction Z of the fifth shield portion 15 are conductively connected.

As shown in FIG. 3, in a blank 200 of a coiled metal strip of the shields 10 formed by bending a metal plate, as a developed metal plate, the first shield portion 11, the second shield portion 12 adjacent to the first shield portion 11 via the first bend portion 21 on one side in the width direction W, and the fourth shield portion 14 adjacent to the first shield portion 11 via the second bend portion 22 on another side in the width direction W are aligned in the width direction W.

In addition, the sixth shield portion 16 adjacent to the first shield portion 11 via the fifth bend portion 25 on the downstream DS side in the feed direction P, the third shield portion 13 adjacent to the second shield portion 12 via the third bend portion 23 on the downstream DS side in the feed direction P, and the fifth shield portion 15 adjacent to the fourth shield portion 14 via the fourth bend portion 24 on the downstream DS side in the feed direction P are aligned in the width direction W.

A T-shaped blank such as in JP2018-137158A that will cover the rearward B side in the third direction X only with the sixth shield portion 16 adjacent to the first shield portion 11 via the fifth bend portion 25 has a longer length L10 in the feed direction P, resulting in a longer feed pitch P1.

Like the present embodiment, by replacing the sixth shield portion 16 covering the rearward B side in the third direction X with the two shield portions, namely the third shield portion 13 adjacent to the second shield portion 12 via the third bend portion 23, and the fifth shield portion 15 adjacent to the fourth shield portion 14 via the fourth bend portion 24, the length L10 in the feed direction P of the blank 200 of the shield 10 can be shortened, so that the feed pitch P1 can be shortened.

Therefore, the feed pitch P1 of the coiled metal strip forming the shields 10 can be shortened in progressive processing, thereby enabling process takt time shortening and material cost reduction.

The height L1 of the third shield portion 13 and the height L4 of the fifth shield portion 15 are set to be the same length, the width L2 of the third shield portion 13 and the width L5 of the fifth shield portion 15 are set to be the same length, and the width L3 of the lead portion 41 and the width L6 of the lead portion 42 are set to be the same length. The height L1 is larger than the length L2, and the height L4 is larger than the length L5. In the present embodiment, the height L1 is twice as long as the length L2. In addition, the height L4 is twice as long as the length L5.

If the height L1 is larger than the length L2, the length L10 in the feed direction P of the blank 200 of the shield 10 is shorter in the case where the third shield portion 13 and the fifth shield portion 15 cover the rearward B side in the third direction X of the housing 100 than in the case where the sixth shield portion 16 covers the rearward B side in the third direction X of the housing 100 with neither the third shield portion 13 nor the fifth shield portion 15 provided. It should be noted that the same applies when the height L4 is larger than the length L5.

In such a case, the feed pitch P1 can be shortened.

Here, if the height L1 is equal to the length L2, or if the height L1 is smaller than the length L2, the length L10 in the feed direction P of the blank 200 of the shield 10 in the case where the third shield portion 13 and the fifth shield portion 15 cover the rearward B side in the third direction X of the housing 100 is equal to, or is longer than, the length 10 in the case where the sixth shield portion 16 covers the rearward B side in the third direction X of the housing 100 with neither the third shield portion 13 nor the fifth shield portion 15 provided. It should be noted that the same applies when the height L4 is equal to the length L5, or when the height L4 is smaller than the length L5.

In such a case, the feed pitch P1 cannot be shortened.

In the shield 10 formed by bending a metal plate, the second shield portion 12 and the fourth shield portion are opposite to each other, the third shield portion 13 is contiguous to the second shield 12, and the fifth shield portion 15 is contiguous to the fourth shield portion 14. Such a shield 10 can ensure an anti-noise shielding function, and can shorten process takt time and reduce material cost.

In the shield 10 formed by bending a metal plate, the sixth shield portion 16 is adjacent to the first shield portion 11 via the fifth bend portion 25, and the sixth shield portion 16 is formed with the first dimple portion 51 as the first conduction path portion, and the second dimple portion 52 as the second conduction path portion on the face 16B on the rearward B side in the third direction X. The conduction paths can be increased that have a short conduction distance for releasing a noise-causing electric current to a portion that does not affect communication signals, so that noise generation can be reduced.

The shield 10 in the first embodiment is provided with the first dimple portion 51 and the second dimple portion 52 as the conduction path portions, whereas the shield 10 in the second embodiment is different in that the third shield portion 13 and the fifth shield portion 15 are provided with a tapered portion at an end of the plate in the second direction Y, and the tapered portions are pressed against each other to form a conduction path portion 53. It should be noted that the same elements as those of the first embodiment are denoted by the same reference signs to omit duplicative descriptions of them.

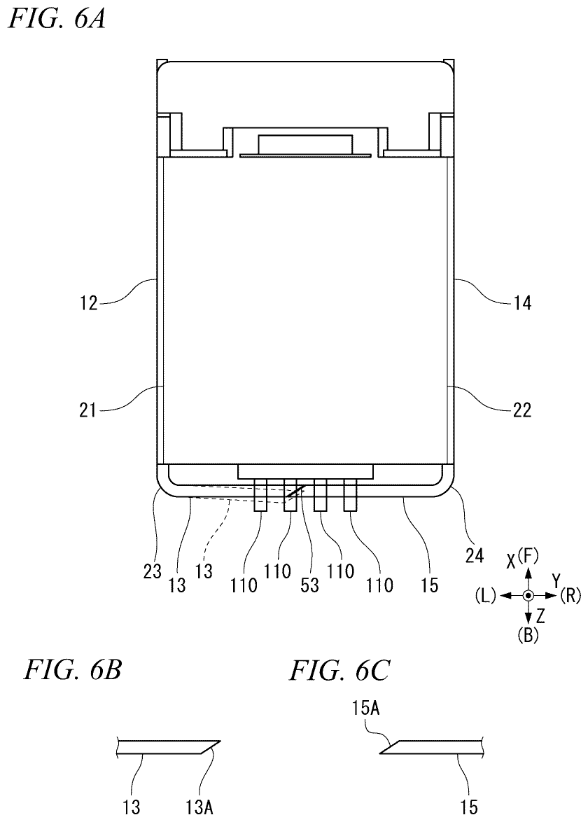

As shown in FIGS. 6A-6C, the conduction path portion 53 as a third conduction path portion, shown in FIG. 6A, is formed by pressing a tapered portion 13A as a first tapered portion formed on the third shield portion 13, shown in FIG. 6B, and a tapered portion 15A as a second tapered portion formed on the fifth shield portion 15, shown in FIG. 6C, against each other. A face of the tapered portion 13A is formed on the rearward B side in the third direction X, and a face of the tapered portion 15A is formed on the frontward F side in the third direction X.

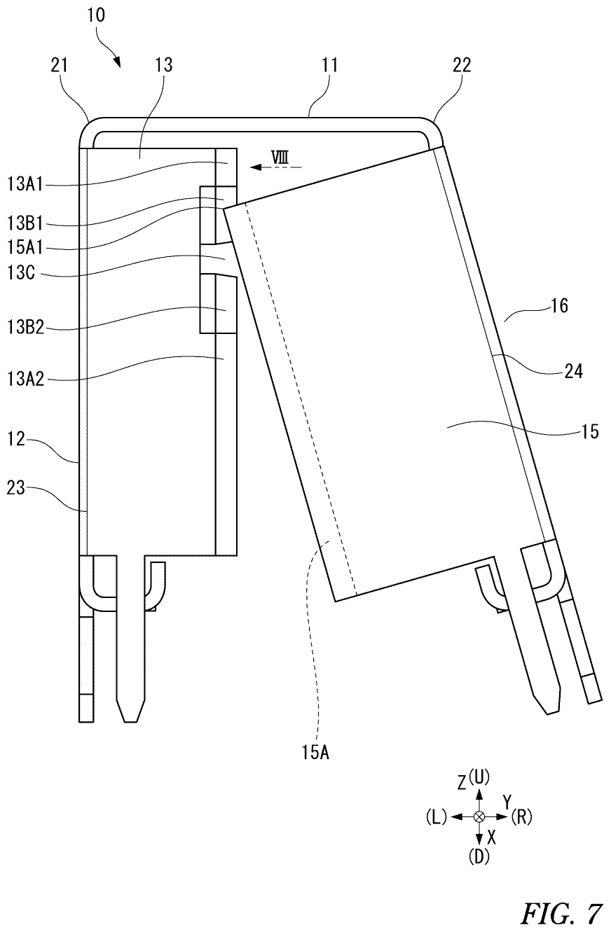

When the shield 10 is formed by bending a metal plate, the third shield portion 13, as drawn in dashed line, is left inclined at a predetermined angle to the second direction Y. In addition, as shown in FIG. 7, the fifth shield portion 15 is made to cover the rearward B side in the third direction X of the housing 100 by bending the metal plate along the fourth bend portion 24, and then bending it along the second bend portion 22.

Once bending along the second bend portion 22 is completed, the tapered portion 13A is pressed by the tapered portion 15A, causing the tapered portion 13 left in a position drawn in dashed line to elastically deform to a position drawn in solid line. At this time, the third shield portion 13 functions as a flat spring to exert a force with which the tapered portion 13A tries to push back the tapered portion 15A.

Since the force of the tapered portion 15A of the fifth shield portion 15 to press the tapered portion 13A and the force with which the tapered portion 13A of the third shield portion 13 functioning as the flat spring tries to push back the tapered portion 15A are generated at the conduction path portion 53, an electrical connection at the conduction path portion 53 can be stabilized.

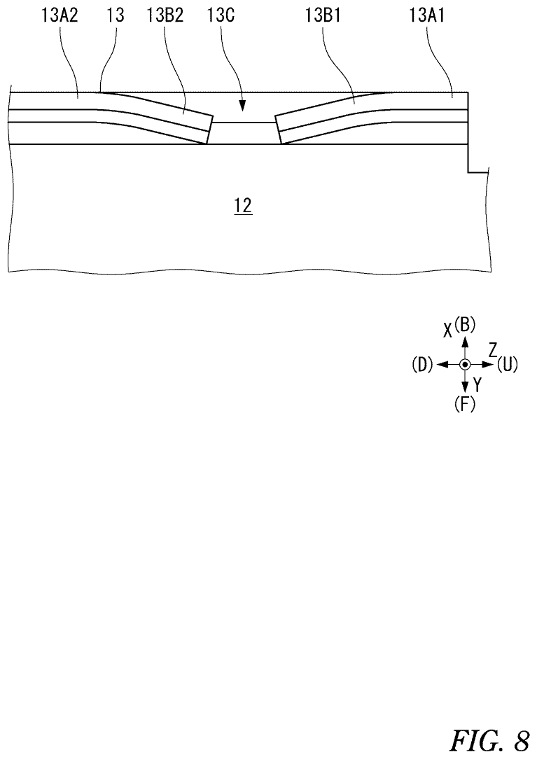

When the metal plate is bent along the second bend portion 22, a distal end 15A1 of the tapered portion 15A of the fifth shield portion 15 comes into contact with the face of the tapered portion 13A, and the face of the tapered portion 13A is scraped by the distal end 15A1. Therefore, the tapered portion 13A is formed with a clearance portion including a sliding face 13B1, a sliding face 13B2, and a gap 13C, as shown in FIG. 8.

The sliding face 13B1 is so formed on the tapered portion 13A as to extend obliquely downward D toward the frontward F side in the third direction X. That is, the sliding face 13B1 extends from the outside of the shield 10 toward the inside thereof away from the third shield portion 13. In addition, the sliding face 13B2 is so formed as to extend obliquely upward U toward the frontward F side in the third direction X. That is, the sliding face 13B2 extends from the outside of the shield 10 toward the inside thereof away from the third shield portion 13. The gap 13C is formed between the sliding face 13B1 and the sliding face 13B2.

Specifically, when the metal plate is bent along the second bend portion 22, the distal end 15A1 of the tapered portion 15A of the fifth shield portion 15 enters the gap 13C. That is, when the second bend portion 22 is the bend portion of the metal plate that is bent last, the gap 13C is formed in a portion where a circle having a radius of the length L5 in the second direction Y of the fifth shield portion 15 with its center at the second bend portion 22 intersects with the first tapered portion 13A.

Thereafter, bending along the second bend portion 22 progresses while the tapered portion 15A is sliding on the sliding face 13B1, and the tapered portion 15A slides on the sliding face 13B2. Finally, the metal plate is bent along the second bend portion 22 to a position where the tapered portion 15A is pressed against the entire face of the tapered portion 13A.

Since the clearance portion including the sliding face 13B1, the sliding face 13B2, and the gap 13C is formed in the face of the tapered portion 13A, generation of metal shavings due to the contact and hard rubbing between the metal plates that occur when the metal plate is bent can be suppressed.

Besides the above, without departing from the spirit of the present invention, the configurations shown in the embodiments described above may be selectively adopted or eliminated, or may be appropriately modified to other configurations.

1. A shield formed by bending a metal plate, comprising:
a first shield portion;
a second shield portion adjacent to the first shield portion;
a fourth shield portion adjacent to the first shield portion and opposite to the second shield portion; and
a third shield portion adjacent to each of the first shield portion, the second shield portion, and the fourth shield portion, the third shield portion includes a first shield sub-portion contiguous to the second shield portion and a second shield sub-portion contiguous to the fourth shield portion.

2. The shield of claim 1, wherein a length of the first shield sub-portion in a first direction orthogonal to the first shield portion is larger than a length of the first shield sub-portion in a second direction orthogonal to the second shield portion.

3. The shield of claim 2, wherein a length of the second shield sub-portion in the first direction is larger than a length of the second shield sub-portion in the second direction.

4. The shield of claim 1, wherein a first conduction path portion conductively connects the first shield portion and the first shield sub-portion.

5. The shield of claim 4, wherein a second conduction path portion conductively connects the first shield portion and the second shield sub-portion.

6. The shield of claim 5, wherein the first conduction path portion and the second conduction path portion are each a dimple portion formed on a sixth shield portion contiguous to the first shield portion.

7. The shield of claim 6, wherein the dimple portions press against the third shield portion to make a conductive connection.

8. The shield of claim 5, wherein the first conduction path portion is a first dimple portion formed on the first shield sub-portion and the second conduction path portion is a second dimple portion formed on the second shield sub-portion.

9. The shield of claim 8, wherein the first dimple portion and the second dimple portion press a sixth shield portion contiguous to the first shield portion to make a conductive connection.

10. The shield of claim 1, further comprising a third conduction path portion conductively connecting the first shield sub-portion and the second shield sub-portion.

11. The shield of claim 7, wherein the third conduction path portion is formed by pressing a first tapered portion formed on the first shield sub-portion against a second tapered portion formed on the second shield sub-portion.

12. The shield of claim 11, wherein a gap is formed in a portion of the first shield sub-portion where a circle having a radius of a length of the second shield sub-portion in a second direction orthogonal to the second shield portion, and a center at a portion at which the fourth shield portion connects to the first shield portion, intersects with the first tapered portion.

13. The shield of claim 12, wherein a sliding face extending from an outside of the shield toward an inside thereof, away from the first shield sub-portion, is formed on at least one side of the gap in a first direction orthogonal to the first shield portion.

14. A communication connector, comprising:
a housing; and
a shield attached to the housing, the shield including a first shield portion, a second shield portion adjacent to the first shield portion, a fourth shield portion adjacent to the first shield portion and opposite to the second shield portion, and a third shield portion adjacent to each of the first shield portion, the second shield portion, and the fourth shield portion, the third shield portion includes a first shield sub-portion contiguous to the second shield portion and a second shield sub-portion contiguous to the fourth shield portion.

15. A blank metal plate of a shield, comprising:
a first shield portion;
a second shield portion adjacent to the first shield portion on a side of the first shield portion in a first direction;
a fourth shield portion adjacent to the first shield portion on another side of the first shield portion in the first direction;
a first shield sub-portion contiguous to the second shield portion and on a side of the second shield portion in a second direction orthogonal to the first direction; and
a second shield sub-portion contiguous to the fourth shield portion and on a side of the fourth shield portion in the second direction.

16. The blank metal plate of claim 15, wherein a length of the first shield sub-portion in the first direction is larger than a length of the first shield sub-portion in the second direction.

17. The blank metal plate of claim 16, wherein a length of the second shield sub-portion in the first direction is larger than a length of the second shield sub-portion in the second direction.
